(19) United States
(12) Patent Application Publication
(10) Pub. No.: US 2005/0030192 A1
(43) Pub. Date: Feb. 10, 2005

(54) Power supply for LED airfield lighting

(76) Inventors: James T. Weaver, Windsor, CT (US); Daniel A. That, South Windsor, CT (US); Kenneth W. Kayser, Catawba, VA (US)

Correspondence Address: FISH & RICHARDSON P.C., 1425 K STREET, N.W., 11TH FLOOR, WASHINGTON, DC, 20005-3500, US

(21) Appl. No.: 10/636,835

(22) Filed: Aug. 8, 2003

(51) Int. Cl. G08B 5/22

(52) U.S. Cl. 340/815.45; 340/953

(57) ABSTRACT

A power supply for LED airfield lighting includes a regulated power supply having a power input, an LED control signal input, and a power output. The power input is configured to be connected to a power source, the LED control signal input is configured to receive an LED control signal, the power output is configured to supply an LED drive current to one or more of the LEDs, and the regulated power supply configured to adjust the LED drive current based upon the LED control signal. The regulated power supply also includes a processor having a current sense input and an LED control signal output connected to the LED control signal input of the regulated power supply. The current sense input is configured to receive a signal corresponding to an airfield current step. The processor is programmed to determine the LED control signal based upon the current sense input signal. The LED control signal is determined so as to enable the LEDs to have a relative intensity approximately equal to relative intensity of an incandescent light source driven at the airfield current step.

### TECHNICAL FIELD

The following description relates to LED airfield lighting, and in particular to a power supply for LED airfield lighting.

### BACKGROUND

Existing airfield lighting systems use incandescent lighting. Intensity controls are provided to vary the intensity of the airfield lighting in accordance with Federal Aviation Administration (FAA) regulations. The intensity of the incandescent lighting is increased by increasing the current output of a power supply to the incandescent lighting. A series of three or five intensity steps typically is employed, depending upon the intended use of the lighting system. The intensity step for the lighting system is selected based upon, for example, the runway visibility range (RVR) and whether the sun has risen or set. For example, the intensity of the lighting system is increased as RVR decreases, and also is increased from the nighttime setting during hours of daylight. As the intensity step is changed, the current supplied to the incandescent lighting is changed in a corresponding manner.

### SUMMARY

Techniques are used to provide a power supply for LED airfield lighting. In particular, techniques are used to adjust the intensity of the LED light source to match the intensity of an incandescent light source at a given intensity step. The intensity is regulated to compensate for other factors, including temperature.

In one general aspect, a power supply for LED airfield lighting includes a regulated power supply having a power input, an LED control signal input and a power output. The power input is configured to be connected to a power source, the LED control signal input is configured to receive an LED control signal, the power output is configured to supply an LED drive current to one or more LEDs, and the regulated power supply is configured to adjust the LED drive current based upon the LED control signal. The regulated power supply also includes a processor with a current sense input and an LED control signal output connected to the LED control signal input of the regulated power supply. The current sense input is configured to receive a signal corresponding to an airfield current step, and the processor is programmed to determine the LED control signal based upon the current sense input signal. The LED control signal is determined so as to enable the LEDs to have a relative intensity appropriately equal to a relative intensity of an incandescent light source driven at the airfield current step.

Implementations may include one or more of the following features. For example, the LED control signal may include a signal indicating a desired effective drive current for the LED. The LED control signal also may include a signal indicating a desired effective intensity for the LED. The current sense input may include a signal proportional to a measured airfield current. The processor may be configured to calculate an RMS voltage of the measured airfield current. The LED control signal may be determined using software. The measured airfield current may be a non-sinusoidal current. A current sensor may be connected to the current sense input of the processor. The regulated power supply may be a switching power supply that may include a switching current regulator. The regulated power supply may be configured to accept a pulse-width modulation input signal in order to pulse-width modulate the LED drive current. The regulated power supply may use pulse-width modulation to adjust the LED drive current. The LED control signal may include a pulse-width modulation control signal.

The processor may further include a temperature input configured to receive a temperature input signal. The processor may be programmed to determine the LED control signal based at least in part upon the temperature input signal. A temperature sensor may be connected to the temperature input. The processor also may be programmed to determined the LED control signal based upon the color of the LED, the age of the LED or the batch of the LED.

The power supply may also include a transformer with an input configured to be connected to an AC power input source and an output connected to a rectifier. The rectifier is connected between the output of the transformer and a power input of a switching current regulator. The transformer may be a ferro-resonant transformer. The current sensor may include a current sense transformer and the switching current regulator may be configured to adjust the LED drive current to simulate a resistive load by adjusting the LED drive current to match a waveform measured by the current sense transformer. The switching current regulator may be configured to adjust the LED drive current to simulate a resistive load by adjusting the LED drive current to match a waveform measured at the rectifier.

The switching current regulator also may be configured to adjust the LED drive current to simulate a resistive load by adjusting the LED drive current to match a waveform measured by the current sense transformer combined with a waveform measured at the rectifier.

The regulated power supply may include a ferro-resonant transformer. The ferro-resonant transformer may be designed to have a high power factor, a high noise immunity, a high surge suppression capability, a high current spike suppression capability, a high voltage spike suppression capability, low conducted emissions, and a high mean time between failure.

The processor may be configured to perform a self-calibration of the current sense input. The self-calibration may be performed to compensate for variations in components of the regulated power supply.

In another general aspect, regulating the intensity of an LED for airfield lighting includes obtaining a desired intensity step and determining an LED drive current based on the desired intensity step. The LED drive current is determined to enable the LED to have a relative intensity approximately equal to a relative intensity of an incandescent light source at an airfield current corresponding to the desired intensity step. Obtaining a desired intensity step may include measuring an AC current. For example, an AC current may be measured using software that calculates an RMS value of the AC current present on the airfield current loop. The AC current may be a non-sinusoidal current. A temperature input may be obtained, and the LED drive current may be determined at least in part by the temperature input. The LED drive current may be determined at least in part by one or more of the color, the age, and the batch of the LED. Determining the LED drive current may include using a table for the determination of the LED drive current and/or the use of a mathematical curve fitting equation.

Other features will be apparent from the description and drawings, and from the claims.

### DESCRIPTION OF DRAWINGS

FIG. 1 is a block diagram of an airfield lighting system that uses a passive power supply for LED airfield lighting.

FIG. 2 is a graph of relative intensity versus the percentage of nominal rated input current for both an LED light source and an incandescent light source.

FIG. 3 is a block diagram of a passive power supply used in the airfield lighting system of FIG. 1.

FIG. 4 is a block diagram of an implementation of the passive power supply of FIG. 3.

FIG. 5 is a flow chart of a process for regulating the intensity of LED airfield lighting using the passive power supply of FIGS. 3 and 4.

### DETAILED DESCRIPTION

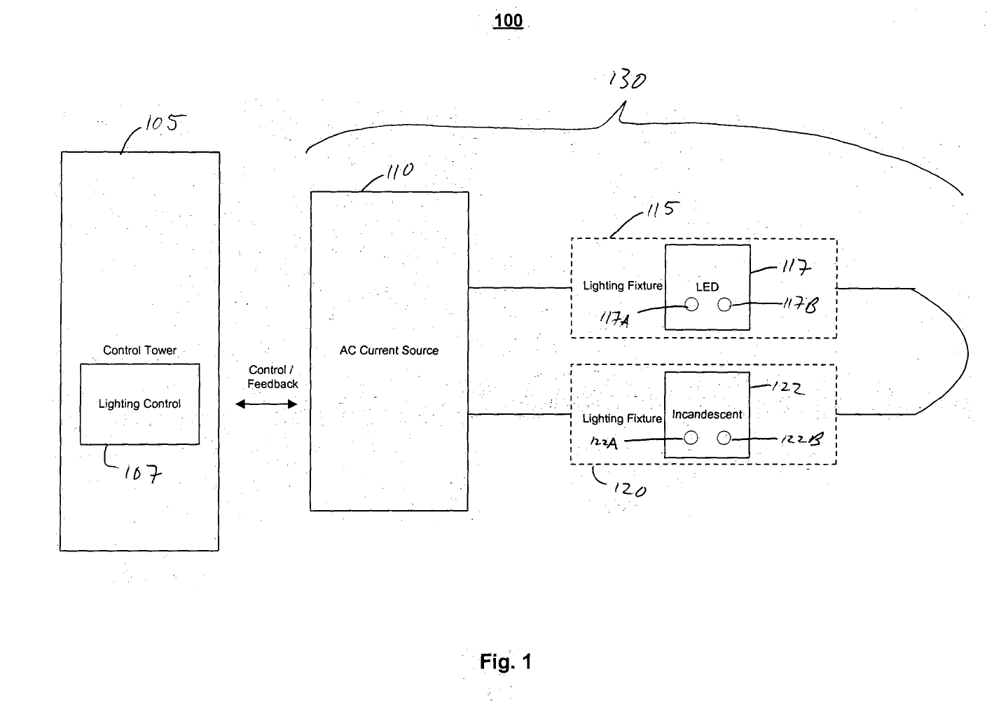

As shown in FIG. 1, an airfield lighting system 100 uses an AC current source 110 to power light fixtures 115 and 120. AC current source 110 typically is a constant current regulator. Light fixtures 115 and 120 may contain, among other things, an isolation transformer, a power supply, and either an LED light source or an incandescent light source. As shown, light fixture 115 contains an LED light source and light fixture 120 contains an incandescent source. In particular, light fixture 115 contains an LED lighting assembly 117 having LEDs 117A and 117B, and light fixture 120 contains an incandescent lighting assembly 122 having incandescent lights 122A and 122B.

The AC current source 110, the lighting fixture 115, and the lighting fixture 120 are connected to form a series current loop 130. Although only two lighting fixtures 115 and 120 are shown, multiple lighting fixtures may be included in the series current loop 130. As previously described, the current flowing in the current loop 130 is adjusted by adjusting the current output from the AC current source 110. Although lighting fixtures 115 and 120 are connected in series within the current loop 130, they are typically connected in such a fashion that a failure in one lighting fixture does not affect the other lighting fixtures. For example, a failure in light fixture 115 does not affect lighting fixture 120.

Typically, an air traffic controller stationed in a control tower 105 monitors and adjusts the lighting system 100 using a lighting control panel 107. The illumination intensity of the airfield lighting may be controlled by manipulating controls in the lighting control panel 107 so as to vary the output current of the AC current source 110. The intensity control may involve a one-way or a two-way communication between the lighting control panel 107 and the AC current source 110. In an example using one-way communication, the air traffic controller stationed in control tower 105 may command various intensity adjustments in the airfield lighting system 100 by manipulating controls in the lighting control panel 107 with no feedback, other than the possible visual feedback obtained by looking out the window of the control tower. In a two-way communication example, the air traffic controller may command intensity adjustments in the airfield lighting system 100 by manipulating controls in the lighting control panel 107, and feedback may be provided to the air traffic controller through the lighting control panel 107 to indicate the present value and status of the current provided by AC current source 110. The control and/or feedback may be provided using known techniques.

The intensity of the airfield lighting is varied in a series of current steps depending upon factors such as the RVR and whether it is daytime or evening, in accordance with FAA regulations. The current steps typically range from 0 to 6.6 amps. The FAA regulations usually specify a series of intensity steps, such as, for example, a series of three or five intensity steps. The intensity of the airfield lighting is controlled by varying the current provided to the light source according to the current steps.

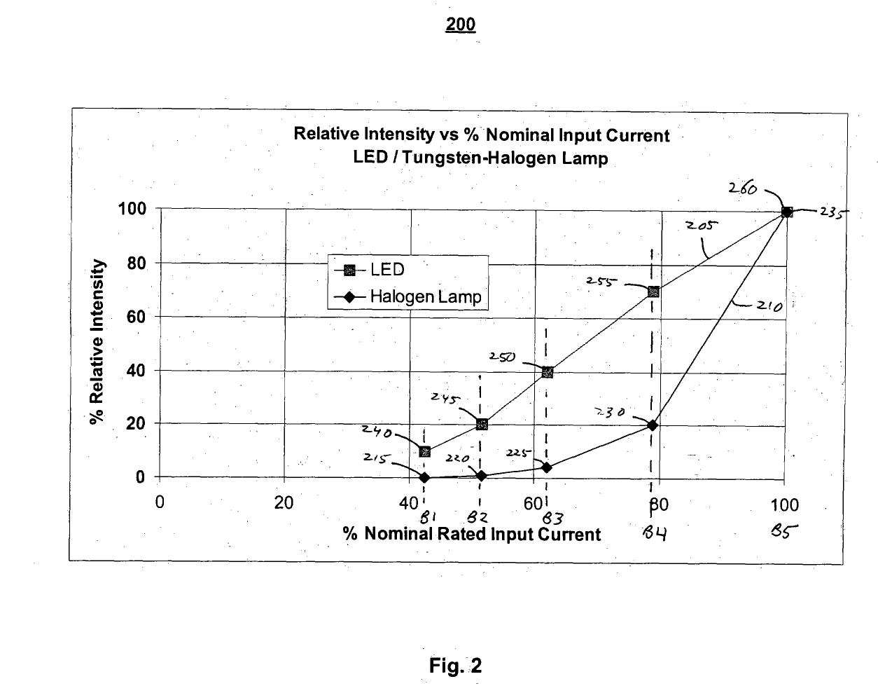

A light fixture 115 containing LED light sources may be used in combination with, or as a replacement for, a light fixture 120 containing an incandescent light source. In order to maintain compliance with FAA regulations, the relative intensity of an LED light source 117 should be the same as the relative intensity of an incandescent light source 122 at a given current step, within an acceptable margin of error. However, as discussed with respect to FIG. 2, the relative intensity of an LED light source 117 in response to a particular percentage value of nominal rated current may differ unacceptably from the relative intensity of an incandescent light source 122 in response to the same percentage value of nominal rated current. For this reason, the relative intensity of the LED light sources 117 needs to be adjusted. This relative intensity adjustment may be accomplished by adjusting the current supplied to the LED light source to achieve the desired relative intensity.

FIG. 2 provides a graph 200 of the percentage of light source relative intensity versus the percentage of nominal rated input current for both an LED light source and an incandescent light source. In particular, the Y axis denotes the relative intensity of the light source and the X axis denotes the input current as a percentage of nominal drive current. For typical airfield incandescent light sources, the nominal drive current is 6.6 A. For LED light sources, the nominal drive current may vary but typically is between 300 mA and 700 mA DC.

As shown, there are five steps labeled B1, B2, B3, B4, and B5. For a typical incandescent implementation, the five steps represent five current levels between 0 and 6.6 A AC provided to the incandescent light sources. Other implementations may include a different number of steps, such as, for example, three steps. Each step from step B1 to B5 represents an increasing current level provided to the light source and, therefore, an increasing relative intensity level.

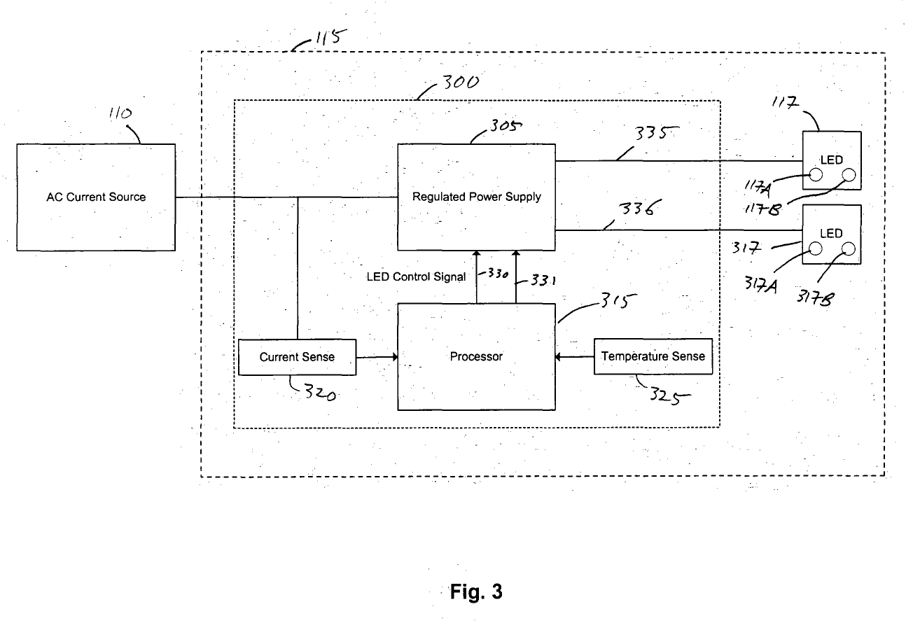

An incandescent curve 205 plots the relative intensity of an incandescent light source against the percentage of the nominal current rating for a five step implementation, and five data points 215, 220, 225, 230, and 235 on the curve 205 are shown corresponding to the five steps. A LED curve 210 plots the relative intensity of a LED light source against the percentage of the nominal current rating for a five step implementation, and five data points 240, 245, 250, 255, and 260 on the curve 210 are shown corresponding to the five steps. As the drive current to the LED light source and the incandescent light source is increased, the relative intensity of each light source increases from 0 to 100 percent. However, the incandescent curve 205 differs from the LED curve 210. In particular, at a given percentage of nominal drive current, the relative intensity given by the incandescent curve 205 typically is lower than the relative intensity given by the LED curve 210. As discussed further with respect to FIG. 3, additional complications may rise due to non-linearities in the AC to DC conversion process that is performed in order to drive the LEDs. For simplicity of discussion, linear relationships will be assumed.

As shown, at step B1 on the X axis (which represents approximately 42% of the nominal drive current), the incandescent light source has a relative intensity of approximately 0.2%, as shown by point 215 and the LED light source has a relative intensity of approximately 10%, as shown by point 240. At step B2 (which represents approximately 52% of the nominal drive current), the incandescent light source has a relative intensity of approximately 1.2% (point 220), and the LED light source has a relative intensity of approximately 20% (point 245) that is greater than the relative intensity at point 220.

Similarly, at step B3 (which represents approximately 62% of the nominal drive current), the incandescent light source has a relative intensity of approximately 4% (point 225) and the LED light source has a relative intensity of approximately 40% (point 250) that is greater than the relative intensity at point 225. At step B4 (which represents approximately 79% of the nominal drive current), the incandescent light source has a relative intensity of approximately 20% (point 230) and the LED light source has a relative intensity of approximately 70% (point 255) that is greater than the relative intensity at point 230. Finally, at step B5 (which represents 100% of the nominal drive current), both the incandescent light source and the LED light source have a relative intensity of 100 percent (points 235 and 260 respectively). As shown, the incandescent curve 205 and the LED curve 210 are non-linear, and the difference in relative intensity between the incandescent source and the LED source is different at steps B1, B2, B3, and B4. With the exception of step B5, the relative intensity of the incandescent source differs from the relative intensity for the LED source when driven at the same percentage of nominal rated input current.

The LED curve 210 may differ depending upon factors including the color of the LED, the temperature, the age of the LED, and the production batch of the LED. Thus, different curves may be obtained for different combinations of these factors. As a result, different adjustments may be required at steps B 1, B2, B3, B4, and B5 for each of the different curves in order to have the LED light source relative intensity equal the incandescent light source relative intensity.

Adjustments may be made at other current values. Such adjustments may be stored in a lookup table, or curve fitting techniques may be used to describe curves 205 and 210.

As shown in FIG. 3, a power supply 300 may be used in a lighting fixture 115 to power LED lighting assemblies 117 and 317. The power supply 300 includes a regulated power supply 305 that is connected to receive an input from the AC current source 110 and configured to supply LED drive current outputs 336 and 337 to LED lighting assemblies 117 and 317.

The power supply 300 also includes a processor 315 that is configured to receive inputs such as a current measurement from a current sensor 320 and a temperature measurement from a temperature sensor 325. In one implementation, the processor 315 is a microcontroller.

A measured current value received from current sensor 320 may correspond to a step described above with respect to FIG. 2. The temperature input from the temperature sensor 325 is used by the processor 315 to account for the variation of the output intensity of an LED in response to temperature. The temperature sensitivity may depend on factors, such as, for example, the color and composition of the LED being used.

In order to drive LED lighting assemblies 117 and 317 to their desired relative intensities, the processor 315 produces an LED control signal 330 for LED lighting assembly 117 and a control signal 331 for LED lighting assembly 317 based upon the inputs of current from the current sensor 320 and, optionally, temperature from the temperature sensor 325. Other inputs (not shown), such as, for example, LED age and batch, may be provided to the processor 315 and taken into account in producing the LED control signals 330 and 331.

The LED control signals 330 and 331 are used as inputs to the regulated power supply 305, which uses the LED control signals 330 and 331 to produce the LED drive currents 335 and 336 that drive LED lighting assemblies 117 and 317, respectively. The LED drive currents 335 and 336 provide a pulse-width modulated (PWM) DC current for the LED light sources 117 and 317 so as to cause the LED light sources 117 and 317 to produce the desired relative intensities. In particular, the pulse-width modulated DC current supplied to each of LEDs 117 and 317 is adjusted such that the relative intensity of the LED light sources is equal, within acceptable tolerances, to the relative intensity of an incandescent light source powered by the current sensed by current sensor 320. As described, LED control signals 330 and 331 represents adjusted currents (i.e., the LED drive currents 335 and 336) that are used to produce the desired relative intensity from the LED lighting assemblies 117 and 317.

The processor 315 typically is located within the lighting fixture 115 and, more particularly, within the power supply 300. The processing to produce LED control signals 330 and 331 may be performed using hardware, software, or a combination thereof. In one implementation, the processing may be performed by using pre-stored values, such as, for example, pre-stored values of curves 205 and 210 in a look-up table. In another implementation, the processing may be done in a dynamic fashion using calculations such as curve fitting algorithms for curves 205 and 210 to compute the LED control signals 330 and 331. The processing may be done one time, such as when a change in current is detected, or the processing may be done continuously to adjust for changes such as, for example, changes in the measured current from the current sensor 320 and the measured temperature from the temperature sensor 325.

The regulated power supply 305, as directed by LED control signal 330, produces the pulse-width modulated DC LED drive currents 335 and 336 having values such that the LED lighting assemblies 117 and 317 have the appropriate relative intensities. The LED control signal 330 for the lighting assembly 117 may differ from the LED control signal 331 supplied to the LED lighting assembly 317 due to differences in performance between the two LEDs. One processor 315 may drive multiple LED lighting assemblies. As shown, the processor 315 drives two lighting assemblies 117 and 317.

The power supply 300 includes a current sensing circuit 320, a temperature sensing circuit 325, and a processor 315. When the AC current source 110 outputs a given current value, the current sensing circuit 320 sends a signal to the processor 315 corresponding to the measured current. The processor 315 determines the appropriate pulse-width modulation value with which to modulate the DC current output 335 of the regulated power supply 305 in order to drive LEDs 117A and 117B to have the desired relative intensity. Similarly, processor 315 separately determines the appropriate pulse-width modulation value with which to modulate the DC current output 336 of the regulated power supply 305 in order to drive LEDs 317A and 317B to have the desired relative intensity.

The temperature sensing circuit 325 sends a signal indicating the measured temperature to the processor 315 which determines how to further modulate the current to drive LEDs 117A, 117B, 317A and 317B. In one implementation, a predefined temperature compensation algorithm or lookup table is used to perform the compensation. The compensation algorithm allows the relative intensities of the LEDs 117A, 117B, 317A and 317B to match that of an incandescent lamp over the 0 to 6.6 amp typical input current range despite variations in color, composition, and temperature of the LEDs being used.

The intensity of an LED is controlled by pulse-width modulation of the DC drive current (e.g., the modulated DC current output 335 of the regulated power supply 305). The output 335 of the power supply 305 is a fixed DC current source which delivers a fixed current to the LED when on, and zero current when off, but varies the on or off time at a given frequency. Thus, the perceived relative intensity of the LED can be varied by controlling the amount of on time and the amount of off time for the LED. The frequency of operation typically is between 200 and 1000 Hz, such as, for example, between 500 and 600 Hz, which is imperceptible to the human eye. The AC current source 110 is converted into a DC current source through regulated power supply 305. There may be a non-linear relationship between the output of the AC current source 110 and the output of the regulated power supply 305.

The appropriate duty cycles that are used to drive LEDs 117A, 117B, 317A and 317B may be determined by experimental evaluation and then programmed into processor 315. The appropriate duty cycle with which to drive the LED depends on factors including the type of LED, the temperature, and the AC current present in the airfield current loop. The factors such as the AC current value and the temperature value are used as the inputs to an algorithm that calculates the appropriate duty cycle that will be used to drive the LEDs. This algorithm may be based upon values that are determined experimentally and are encoded in software. As shown, the processor 315 has two outputs 330 and 331 that are control signals indicating a desired pulse-width modulation and that can be controlled independently. The frequency of the desired pulse-width modulation is determined by software that is executed by the processor 315 and typically is set above 60 Hz, for example, above 120 Hz, so that the human eye cannot detect the on-off transitions of the LEDs 117A, 117B, 317A and 317B as they are pulse-width modulated.

The PWM signal is fed into a regulated power supply 305. As shown, power supply 305 is a dual current source, and has two independent control inputs 330 and 331 and two independent PWM DC current outputs 335 and 336. The LEDs are current driven devices (i.e., they are specified by their operating currents because small changes in voltage correspond to large changes in current) and are driven with a current source instead of a voltage source. The DC current source has the capability of being pulse-width modulated such that it delivers a fixed level of current when the control signal is high and delivers zero current (or alternatively a second, lower level of current) when the control signal is low. The DC current source responds quickly enough to allow for sharp “on-off-on” currents at the outputs 335 and 336 driving the LEDs. As shown, the DC current source is a switching power supply designed at a frequency of about 40 kHz, which allows for DC current regulation with smaller components than would be needed at lower frequencies. Also, the efficiency of a switching power supply is greater than that of a linear current source, and therefore more effectively transfers power from input to output.

Current measurements are taken by sampling the current waveform with an analog-to-digital converter, which is then input to the processor 315. An algorithm running in the processor 315 is used to calculate the true RMS value of the current from the samples. This measurement and calculation is repeated frequently, such as, for example every 200 milliseconds. Temperature measurements are also taken using an analog-to-digital converter and input to the processor 315 frequently, such as, for example every 200 milliseconds.

The LED fixture 115 typically has one power supply 300 per fixture 115. A bidirectional fixture, which uses two LED light assemblies can be driven by one power supply with two output channels 335 and 336. The outputs 335 and 336 are independent, and may be individually pulse-width modulated as determined, for example, by separate compensation algorithms.

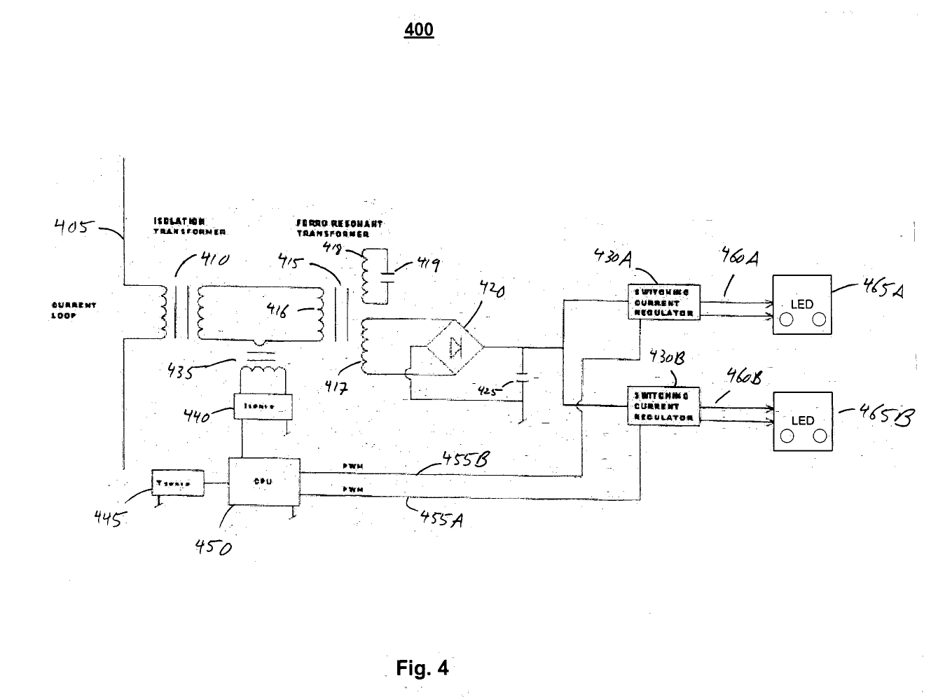

As shown in FIG. 4, a power supply 400 may be used in a lighting fixture to drive LED light sources in an airport lighting system 100. Power supply 400 is one possible implementation of the power supply 300 described above with respect to FIG. 3. An AC current loop 405 provides AC power to an isolation transformer 410. As described above, the current loop 405 typically is a zero to 6.6 amp variable current circuit where the current in the circuit varies as the desired intensity step is varied by a controller manipulating controls in the lighting control panel 107.

A ferro-resonant transformer 415 is connected to the output of the isolation transformer 410. The ferro-resonant transformer effectively converts the input AC current into an AC voltage. Using such a ferro-resonant design, the output AC voltage ideally will not vary as the input current varies, so as to allow for the isolation of electrical noise and to provide voltage or current spike protection for the power supply. Power factor correction is inherent in the ferro-resonant design, and provides compensation for out-of-phase current and voltage at the primary winding of the isolation transformer 410.

The ferro-resonant transformer has three windings 416, 417, and 418. A capacitor 419 is connected to winding 418. A rectifier 420 is connected to the output of the ferro-resonant transformer 415. The output of the rectifier 420 is filtered by filter 425, which may be, for example a capacitor or a capacitor combined with a choke. Other components, such as a voltage regulator (not shown), may be included. The DC output of the filter 425 is used to drive two switching current regulators 430A and 430B for two LED light sources 465A and 465B. The current regulators 430A and 430B typically provide a DC nominal currents 460A and 460B to the LED light sources 465A and 465B, so as to drive them at full intensity. Current regulators 430A and 430B can be independently pulse-width modulated by the processor 450, so as to control the relative intensity of the LEDs 465A and 465B.

A measurement for the current passing through the current loop 405 is obtained through a current sense transformer 435 and signal conditioning circuitry 440. The processor 450 determines the RMS value of current in the current loop 405 through software calculations based on the measured current input. The RMS current information, along with temperature information provided by the temperature sensing circuit 445, is used by an algorithm to determine the appropriate pulse-width modulation duty cycle with which to drive the LED light sources 465A and 465B. The algorithm may differ depending on factors such as the color and the type of the LED, and typically is programmed at the time of manufacture. The algorithm may be determined by obtaining experimental data for LED characteristics such as color and type of LED.

Switching current regulators 430A and 430B typically use pulse width modulation (PWM) to modulate the DC current and thereby adjust the percentage of the time that the LED light sources 465A and 465B are illuminated. In effect, the switching current regulators 430A and 430B blink the LED light sources 465A and 465B at rates that are faster than the human eye can detect. By blinking the LED light sources 465A and 465B, and thereby changing the percentage of the time the LEDs are on, the relative intensity of the LEDs may be increased or decreased. The relative intensity increases with an increase in the percentage of time that the LED light sources are on.

The processor 450 uses the algorithm to determine LED control signals 455A and 455B that provide the appropriate PWM duty cycle to switching current regulators 430A and 430B. The determination of the LED control signals 455A and 455B may be done using hardware, software, or a combination of hardware and software.

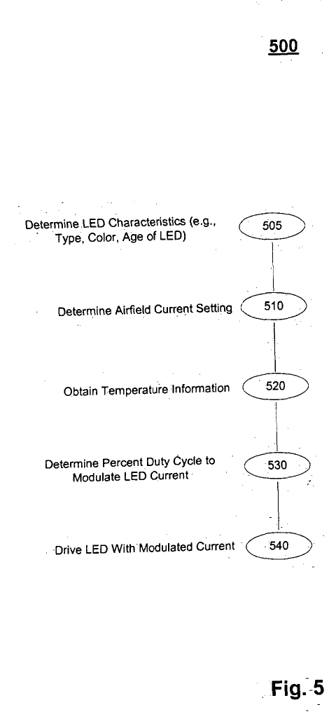

FIG. 5 shows a process 500 for regulating the effective intensity of LEDs in airfield lighting. The process 500 uses a power supply such as, for example, power supply 300 or 400 discussed with respect to FIGS. 3 and 4.

First, LED characteristics such as the type, age, and color of the LED are determined and programmed into the power supply (step 505). In one implementation, the characteristics are programmed at the time of manufacture. A fixture typically is either one-sided or two-sided, with each side having different characteristics such as, for example, a different color or type. Each side typically is controlled by a different algorithm. However, in other implementations, the same algorithm may control both sides of a two-sided fixture.

When the fixture is installed in the airfield lighting system, a current sensor 320, 435 or 440 is used to measure the AC current (step 510) as described previously with respect to FIGS. 3 and 4. Thus, determining the airfield current setting may include obtaining current information by receiving an input from a current sensor. In another implementation, determining the airfield current setting may include receiving the airfield current setting directly as, for example, a value corresponding to the airfield current setting.

The ambient temperature is measured (step 520) using a temperature sensor such as temperature sensors 325 and 445 described with respect to FIGS. 3 and 4.

The processor 315 or 450 determines the percent duty cycle with which to drive the LEDs (step 530), and the LEDs are driven accordingly (step 540).

Determining the desired percent duty cycle may include calculating the PWM value to be applied to a current used to illuminate an LED light source from the measured current information and the temperature information. As a result, the relative intensity of the LED light source matches the relative intensity of an incandescent light source, within tolerable limits, for a given measured RMS current in the current loop.

The percentage duty cycle may be determined by retrieving information from prestored tables and performing a table look up. The modulation values stored in the look-up tables may be determined experimentally for each of the different variations for each factor, including various current values, temperatures, colors of LED light source, and ages and batches of LEDs. In one implementation, separate look up tables may be used for each of the factors to be applied, such as color, age, and batch of the LED, and may be maintained and applied in a serial fashion to determine the final value of the desired LED current. In another implementation, a single set of look up tables are used for the different combinations of the factors.

Alternatively, a calculation using an interpolation, curve fitting, or other appropriate technique may be used to dynamically compute the appropriate value of the percentage of duty cycle. A single algorithm or different algorithms may be used to account for the various factors. Computations may be done separately for each factor considered or, alternatively, the computations may be performed together one time to account for the desired features.

The PWM LED current determined in step 530 corresponds, for example, to the LED control signals 330 and 331 discussed with respect to FIG. 3 and the LED control signals 455A and 455B discussed with respect to FIG. 4. The desired PWM LED current may be determined using hardware, software, or a combination of hardware and software.

The processing may be done one time, when changes in current are detected, or continuously to adjust for changes to input values such as, for example, changes in the measured current and temperature. The desired PWM LED current, when applied to the LED light source, will result in the LED light source having the same relative intensity, within acceptable tolerances, as the relative intensity of an incandescent light source driven by the current in the airfield current loop.

The order of the steps may be varied and certain steps may be omitted altogether. For example, temperature information may be obtained 520 before the airfield current setting is obtained 510.

A number of implementations have been described. Nevertheless, various modifications may be made. Accordingly, other implementations are within the scope of the following claims.

1. A power supply for LED airfield lighting comprising:
a regulated power supply comprising a power input, an LED control signal input, and a power output, wherein:
the power input is configured to be connected to a power source, the LED control signal input is configured to receive an LED control signal, the power output is configured to supply an LED drive current to one or more LEDs, and
the regulated power supply is configured to adjust the LED drive current based upon the LED control signal; and
a processor having a current sense input and an LED control signal output connected to the LED control signal input of the regulated power supply, wherein:
the current sense input is configured to receive a signal corresponding to an airfield current step and,
the processor is programmed to determine the LED control signal based upon the current sense input signal, wherein the LED control signal is determined to enable the LEDs to have a relative intensity approximately equal to a relative intensity of an incandescent light source driven at the airfield current step.

2. The power supply of claim 1 in which the LED control signal comprises a signal indicating a desired effective drive current for the LED.

3. The power supply of claim 1 in which the LED control signal comprises a signal indicating a desired effective intensity for the LED.

4. The power supply of claim 1 in which the current sense input comprises a signal proportional to a measured airfield current.

5. The power supply of claim 4 in which the processor is configured to calculate an RMS voltage of the measured airfield current.

6. The power supply of claim 1 in which the LED control signal is determined using software.

7. The power supply of claim 5 wherein the measured airfield current is a non-sinusoidal current.

8. The power supply of claim 4 further comprising a current sensor connected to the current sense input of the processor.

9. The power supply of claim 1 in which the regulated power supply comprises a switching power supply.

10. The power supply of claim 9 in which the switching power supply comprises a switching current regulator.

11. The power supply of claim 9 in which the regulated power supply is configured to accept a pulse-width modulation input signal to pulse-width modulate the LED drive current.

12. The power supply of claim 9 in which the regulated power supply uses pulse width modulation to adjust the LED drive current.

13. The power supply of claim 12 in which the LED control signal comprises a pulse width modulation control signal.

14. The power supply of claim 1 in which the processor further comprises a temperature input configured to receive a temperature input signal, wherein the processor is programmed to determine the LED control signal based at least in part upon the temperature input signal.

15. The power supply of claim 14 further comprising a temperature sensor connected to the temperature input.

16. The power supply of claim 1 in which the processor is programmed to determine the LED control signal based upon at least one of a color of an LED, an age of an LED and a batch of an LED.

17. The power supply of claim 1 further comprising a transformer comprising an input configured to be connected to an AC power input source and an output connected to a rectifier, wherein the rectifier is connected between the output of the transformer and a power input of a switching current regulator.

18. The power supply of claim 17 in which the transformer comprises a ferro-resonant transformer.

19. The power supply of claim 18 wherein the current sensor comprises a current sense transformer and wherein the switching current regulator is configured to adjust the LED drive current to simulate a resistive load by adjusting the LED drive current to match a waveform measured by the current sense transformer.

20. The power supply of claim 18 wherein the switching current regulator is configured to adjust the LED drive current to simulate a resistive load by adjusting the LED drive current to match a waveform measured at the rectifier.

21. The power supply of claim 18 wherein the current sensor comprises a current sense transformer and wherein the switching current regulator is configured to adjust the LED drive current to simulate a resistive load by adjusting the LED drive current to match a waveform measured by the current sense transformer combined with a waveform measured at the rectifier.

22. The power supply of claim 1 wherein the regulated power supply comprises a ferro-resonant transformer.

23. The power supply of claim 22 wherein the ferro-resonant transformer is designed to have one or more of a high power factor, a high noise immunity, a high surge suppression capability, a high current spike suppression capability, a high voltage spike suppression capability, low conducted emissions, and a high mean time between failure.

24. The power supply of claim 1 wherein the processor is configured to perform a self-calibration of the current sense input.

25. The power supply of claim 24 wherein the self-calibration is performed to compensate for variations in components of the regulated power supply.

26. A power supply for LED airfield lighting comprising:
a regulated power supply comprising:
means for supplying an LED drive current to one or more LEDs;
means for receiving a signal corresponding to an airfield current step;
means for determining an LED control signal based upon the received signal, wherein the LED control signal is determined to enable the LEDs to have a relative intensity approximately equal to a relative intensity of an incandescent light source driven at the airfield current step;
means for receiving the LED control signal; and
means for adjusting the LED drive current based upon the LED control signal.

27. The power supply of claim 26 in which the means for determining the LED control signal further comprises means for receiving a temperature input signal, wherein the LED control signal is determined based at least in part upon the temperature input signal.

28. The power supply of claim 26 further comprising a transformer comprising an input configured to be connected to an AC power input source and an output connected to a rectifier, wherein the rectifier is connected between the output of the transformer and a power input of a switching current regulator.

29. The power supply of claim 28 in which the transformer comprises a ferro-resonant transformer.

30. A method of regulating the intensity of an LED for airfield lighting, the method comprising:
obtaining a desired intensity step; and
determining an LED drive current based on the desired intensity step, wherein the LED drive current is determined to enable an LED to have a relative intensity approximately equal to a relative intensity of an incandescent light source at an airfield current corresponding to the desired intensity step.

31. The method of claim 30 wherein obtaining a desired intensity step comprises measuring an AC current.

32. The method of claim 31 wherein measuring an AC current comprises measuring an AC current using software, the software calculating an RMS value of an AC current present on an airfield current loop.

33. The method of claim 32, wherein the AC current is a non-sinusoidal current.

34. The method of claim 30 further comprising obtaining a temperature input and wherein the LED drive current is determined at least in part by the temperature input.

35. The method of claim 30 further comprising obtaining at least one of a color of an LED, an age of an LED, and a batch of the LED, and wherein the LED drive current is determined at least in part by at least one of the color, the age, and the batch of the LED.

36. The method of claim 30 wherein determining the LED drive current comprises determining the LED drive current using a table.

37. The method of claim 30 wherein determining the LED drive current comprises determining the LED drive current using a mathematical curve fitting equation.
